(19) United States
(12) Patent Application Publication
(10) Pub. No.: US 2020/0394730 A1
(43) Pub. Date: Dec. 17, 2020

(54) FACILITY MANAGEMENT LOCAL SERVER AND PROXY MANAGEMENT CENTER SERVER

(71) Applicant: Mitsubishi Electric Corporation, Tokyo (JP)

(72) Inventors: Hiroki KAWANO, Tokyo (JP); Morimasa YOKOTA, Tokyo (JP); Toshihiro MEGA, Tokyo (JP); Naoko HOMMA, Tokyo (JP); Tomooki UKIANA, Tokyo (JP)

(73) Assignee: Mitsubishi Electric Corporation, Tokyo (JP)

(21) Appl. No.: 16/770,863

(22) PCT Filed: Dec. 14, 2017
(86) PCT No.: PCT/JP2017/044844

§ 371 Date: Jun. 8, 2020

(51) Int. Cl. G06Q 50/16; H04L 29/08; G06Q 10/00

(52) U.S. Cl. CPC G06Q 50/163; G06F 3/04847; G06Q 10/20; H04L 67/28

(57) ABSTRACT

A facility management local server is provided with a proxy work management unit that is communicatively coupled to a proxy management center server. If an error code is output while maintenance work that results in a change in a set value stored in a set value storage unit is being performed in a building to be maintained, the proxy work management unit allows proxy maintenance work to be performed via remote control from a maintenance worker terminal device that is communicatively coupled to the center server. Further, the proxy work management unit can display, on display units provided in the building to be maintained, a proxy request screen including an error code input field and an input field for receiving an input of the content of the maintenance work that was being performed in the building to be maintained when the error code was output.

### TECHNICAL FIELD

The present disclosure relates to a facility management local server which manages maintenance of facilities of a maintained building, and a proxy management central server which is communicatively connected to the local server.

### BACKGROUND

A so-called “facility management service” that operates and manages real estate such as buildings includes maintenance tasks to maintain facilities of a maintained building in a normal (or optimal) status.

As one of the maintenance tasks, maintenance services using a remote network (remote maintenance) are known, as disclosed in, for example, Patent Literatures 1 and 2. For example, a local server which is installed at a maintained building and a central server which is installed in a central building are connected via remote network such as the Internet or a dedicated communication line. Signals of various types are sent from devices of facilities of the maintained building (local building) to the central server via the local server. For example, in a heating, ventilation, and air conditioning (HVAC) facility, a temperature sensor, a humidity sensor, an air flow sensor, a controller, and other devices of the facility output operation signals indicative of a temperature, humidity, air flow rate, or ON/OFF state, and abnormal signals indicative of an abnormal temperature and an abnormal air flow rate. As another example, in an elevator facility, a destination button, a call button on each floor, a car door motor, and other devices of the elevator facility output operation signals indicative of a destination floor, a calling floor, or other operation information, and abnormal signals indicative of a door opening/closing failure, or other abnormal status information.

The central server is configured to be able to change and update various set values of the local server through remote operations. For the HVAC facility, a temperature set value may be seasonally changed. For the elevator facility, settings of skipped floors can be changed by changing accessible floors in accordance with, for example, tenant occupancy.

Even when various set values of the local server can be changed from the central server through remote operations, on-site maintenance such as a periodical visit of a maintenance operator to the maintained building to change set values of the local server may still be required in accordance with a maintenance contract or other requirements. On-site maintenance may also be performed for a purpose of training a maintenance operator with limited experience by letting the maintenance operator change set values while confirming the actual behavior of the device at the site.

For on-site maintenance, for example, in Patent Literature 3, operator candidates are extracted based on the task and the information of operators assigned for the facility, such as a technical level and qualifications. In Patent Literature 4, candidates are selected based on experience, skills, qualifications, and other information in order to dispatch an operator with a corresponding quality in case of emergency.

### CITATION LIST

### Patent Literature

Patent Literature 1: JP 2008-275317 A

Patent Literature 2: JP 2002-106930 A

Patent Literature 3: JP 2009-128918 A

Patent Literature 4: JP 2016-096574 A

### SUMMARY

### Technical Problem

During on-site maintenance operations, abnormal behavior of a device may be caused by a change in set values. In such a case, for example, when a maintenance operator with limited experience performs maintenance operations, the cause of the abnormal behavior may remain unknown. As described above, because a local server can be remotely operated from a central server, the on-site maintenance operations may be assisted by a proxy operator from a central building. An object of the present disclosure is to provide a facility management local server and a central server that are configured to assist on-site maintenance operations through a proxy operation from a remote site when a device is in an abnormal status during the on-site maintenance operations.

### Solution to Problem

The present disclosure relates to a facility management local server that is communicatively connected to a device of a facility of a maintained building. The local server includes a send section that is configured to send a control signal to the device, a receive section that is configured to receive a signal indicative of an operation status of the device, an output section that is configured to output an error code that encodes identification information of the device and description of an abnormal status when abnormal behavior of the device is detected, and a set value storage that is configured to store set values of the device. The local server further includes a proxy operation manager that is communicatively connected to a proxy management central server. The proxy operation manager is configured to enable a proxy operation through a remote operation from a maintenance operator's terminal that is communicatively connected to the proxy manager central server when the error code is outputted during a maintenance operation at the maintained building to change a set value stored in the set value storage. The proxy operation manager is configured to display a proxy request screen on a display disposed at the maintained building. The proxy request screen includes an entry field for the error code and another entry field for description of the maintenance operation being performed at the maintained building at the time of output of the error code.

According to the above configuration, when requesting a proxy maintenance operation, it is possible to enter an error code and description of the maintenance operation at the maintained building at the time of output of the error code. Although the error code records the identification information of the device having the abnormal behavior and the description of the abnormal status, such information may be insufficient to identify the cause of the abnormal behavior. In the present disclosure, because the description of the maintenance operation being performed at the maintained building at the time of output of the error code can be entered in addition to the error code, the proxy operation can be requested with the cause of the abnormal behavior being clarified.

In the above disclosure, the proxy operation manager may also send identification information of the local server when sending, to the central server, the error code and the description of the maintenance operation entered on the proxy request screen.

By sending the identification information of the local server, the name of a property at which the local server is installed can be identified. In this way, entry of the specific property name by the on-site maintenance operator can be omitted.

In the above disclosure, the proxy operation manager may be configured to display, on a display, description of remote operation performed through the terminal and description of a checking operation to be performed at the maintained building.

With the display displaying the description of the performed remote operation, the on-site maintenance operator at the maintained building can understand what is performed through the remote operation.

Another embodiment of the present disclosure relates to the proxy management central server that is communicatively connected to the facility management local server. The facility management local server is communicatively connected to a device of a facility of a maintained building. The facility management local server is configured to send a control signal to the device and receive a signal indicative of an operation status of the device. The central server includes a proxy operator selector configured to select a maintenance operator who performs a proxy operation from a terminal through a remote operation to the local server when receiving, from the local server, an error code encoding identification information of the device and description of an abnormal status, both outputted when abnormal behavior of the device is detected, and proxy request information including description of a maintenance operation being performed at the maintained building at the time of output of the error code. The maintenance operator is selected from maintenance operators who operate terminals that are communicatively connected to the proxy management central server.

According to the above configuration, when receiving a proxy request from a local server, the local server sends the error code and description of the maintenance operation being performed at the maintained building at the time of output of the error code. In the present disclosure, the cause of the abnormal behavior can be clarified by receiving, in addition to the error code, the description of the maintenance operation that is performed at the maintained building at the time of output of the error code and possibly the cause of the abnormal behavior.

In the above disclosure, the proxy operator selector of the central server may include an error code analyzer and a property identifier. The error code analyzer is configured to analyze the identification information of the device having abnormal behavior and the description of the abnormal behavior based on the received error code. The property identifier is configured to obtain information on the maintained building based on identification information of the local server sent from the local server along with the error code and the description of the maintenance operation when receiving the proxy request information.

The analyzation of the error code leads to the identification of the device having the abnormal behavior and the abnormal status itself. Further, the name of the property at which the local server is installed can be identified based on the identification information of the local server. In this way, specific description of the proxy operation can be obtained.

In the above disclosure, the proxy operator selector of the central server may include a candidate extractor, a terminal activity status obtainer, and a request order setter. The candidate extractor extracts, from the maintenance operators who operate the terminals, maintenance operators who have maintenance experience for the building to be maintained identified by the property identifier based on operation records of the maintenance operators. The terminal activity status obtainer obtains information as to whether or not an operating system of the terminal has been started, and an entry record to the terminal. The request order setter determines an order of the maintenance operators extracted by the candidate extractor to request the proxy operation based on the information as to whether the operating system has been started and the entry record to the terminal.

A prompt response to the proxy operation request becomes possible by extracting the maintenance operators who have maintenance experience for the building to be maintained at which the local server requesting the proxy operation is located and obtaining the activity status of the terminals of the extracted maintenance operators.

In the above disclosure, the request order setter may determine a request order of the maintenance operators to request a remote operation to the local server by assigning a higher priority to the maintenance operators who have been extracted by the candidate extractor, whose operating system has been started, and who have performed an entry operation to the terminal during a latest checking period, than to the maintenance operators who have been extracted by the candidate extractor, whose operating system has been started, but who have performed no entry operation to the terminal during the latest checking period.

The entry status to the terminal implies whether or not the maintenance operator is available at the desk. A prompt reply indicating acceptance or rejection of the proxy operation can be obtained by assigning a higher priority to the maintenance operators who are available at the desk with the terminal when the proxy operation is requested.

In the above disclosure, the proxy operator selector of the proxy management central server may include a maintenance operator database that is configured to store, for each of the maintenance operators, a proxy acceptance rate indicative of a rate at which the maintenance operator has accepted proxy operations. In this case, the request order setter assigns a higher priority to the maintenance operators who have been extracted by the candidate extractor, whose operation system has been started, and who have performed an entry operation to the terminal during a latest checking period when determining the order to request the proxy operation.

The proxy operation can be started soon by assigning a higher priority to the maintenance operators having a high proxy acceptance rate.

### Advantageous Effects of Disclosure

According to the present disclosure, when abnormal behavior occurs during on-site maintenance operations, assistance to the on-site maintenance operations is possible from a remote site.

### BRIEF DESCRIPTION OF DRAWINGS

FIG. 1 is a diagram exemplarily showing a facility maintenance management system according to an embodiment of the present disclosure, including a facility management local server and a proxy management central server;

FIG. 2 is a diagram exemplarily showing function blocks of a remote operation controller of the central server;

FIG. 3 is a system configuration diagram exemplarily showing a facility management system of the local server;

FIG. 4 is a diagram exemplarily showing a part of function blocks of the local server;

FIG. 5 is a diagram exemplarily showing a screen at start-up of the facility management system;

FIG. 6 is a diagram exemplarily showing a set value changing screen of the facility management system;

FIG. 7 is a diagram showing an exemplary display when an error code is displayed on a screen of the facility management system;

FIG. 8 is a diagram showing a proxy request flow according to the embodiment of the present disclosure;

FIG. 9 is a diagram exemplarily showing a proxy request entry screen of the local server;

FIG. 10 is a diagram showing contents of maintenance operator database at a remote operation controller of the central server;

FIG. 11 is a diagram showing operator available probability parameters based on an activity status of an operating system and an input status of a keyboard;

FIG. 12 is a table exemplarily showing a proxy operation query list;

FIG. 13 is a diagram exemplarily showing a proxy operation request screen displayed on a terminal of each maintenance operator;

FIG. 14 is a diagram exemplarily showing a screen to be displayed on the local server when a proxy operator has been found;

FIG. 15 is a diagram exemplarily showing a screen to be displayed on the local server when no proxy operator has been found; and

FIG. 16 is a diagram exemplarily showing a facility maintenance management system according to another embodiment of the present disclosure, including a local server and a central server.

### DESCRIPTION OF EMBODIMENTS

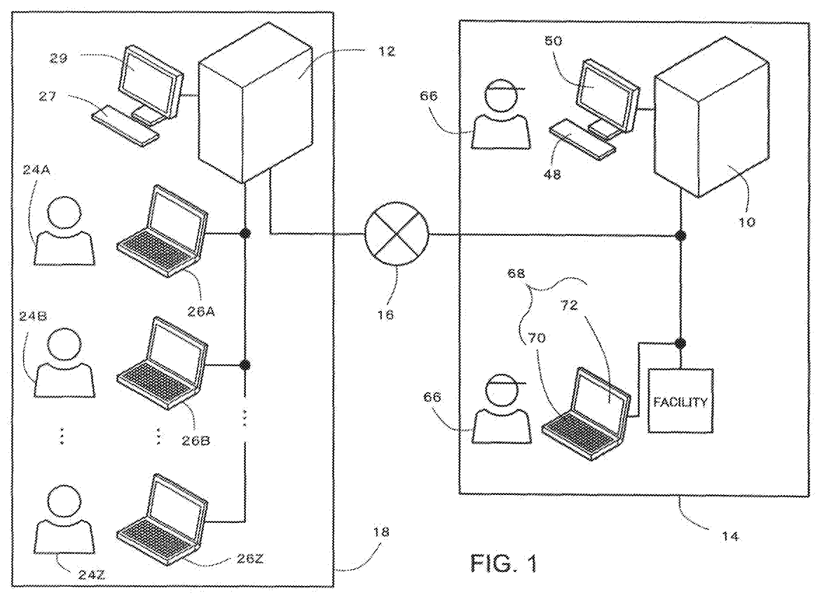

FIG. 1 exemplarily shows a facility maintenance management system according to an embodiment of the present disclosure, including a local server 10 and a central server 12. The facility maintenance management system is a so called “facility management service system”. The local server 10 is configured as a part of a so called “building energy management system (BEMS)”.

The local server 10 and the central server 12 are communicatively connected to each other through a network 16, such as the Internet or dedicated communication lines. In addition to the local server 10, other local servers that manage facilities of other maintained buildings may be communicatively connected to the central server 12. FIG. 1 omits the other local servers.

The central server 12 is a computer that centrally manages information received from local servers including the local server 10, and can perform remote operations to the local servers including the local server 10.

The central server 12 is, for example, a proxy management computer (a proxy management central server) that is installed in a central building 18 where a service center providing facility services is located. The central server includes a central processing unit (CPU), a memory, and an input/output interface, all of which are not shown and connected via a system bus.

The memory may be configured with volatile or nonvolatile memories (storage media) including, for example, a memory such as a random access memory (RAM) or a read only memory (ROM), and a storage device such as a hard disk.

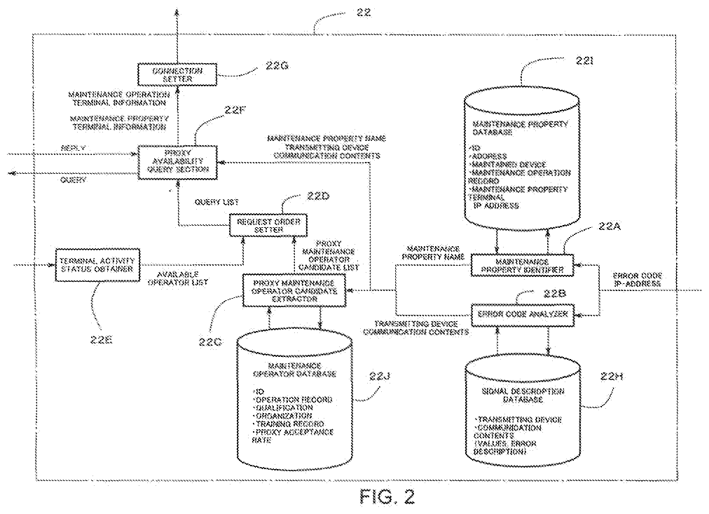

As described below, the memory stores programs that cause the central server 12 to function as a proxy operator selector 22 exemplarily shown in FIG. 2. Alternatively, the central server 12 may be made to function as the proxy operator selector 22 by reading storage media such as a CD-ROM or DVD which stores the programs.

The central server 12 functions as the proxy operator selector 22 when the above programs are read and executed by the CPU of the central server 12. As described further below, in response to an error code along with description of the on-site maintenance operation being performed at the time of output of the error code, the proxy operator selector 22 selects, from central maintenance operators 24A to 24Z who operate respective central terminals 26A to 26Z, a maintenance operator who will perform the proxy operation through a remote operation to the local server 10 from the corresponding central terminal 26A to 26Z.

FIG. 2 exemplarily shows a configuration of the proxy operator selector 22. The proxy operator selector 22 includes, as processing sections, a maintenance property identifier 22A, an error code analyzer 22B, a proxy maintenance operator candidate extractor 22C, a request order setter 22D, a terminal activity status obtainer 22E, a proxy availability query section 22F, and a connection establisher 22G. The proxy operator selector 22 further includes a signal description database 22H, a maintenance property database 22I, and a maintenance operator database 22J. As these databases, at least a portion of the memory of the central server 12 is assigned. The operations of the processing sections and database are described below.

Returning to FIG. 1, the terminals 26A to 26Z which are respectively assigned to the maintenance operators 24A to 24Z are located in the central building 18. However, the terminals 26A to 26Z are not limited to those located in the central building 18. The terminals 26A to 26Z may be located external to the central building 18 and communicatively connected to the central server 12 via a network, such as the Internet. In the description below, the terminals 26A to 26Z are called “central terminals” as required.

The central terminals 26A to 26Z may be so called “thin client terminals”, performing minimum functions, each with a display and an input section. Images or other information generated by the central server 12 are displayed on the display of the respective central terminals 26A to 26Z. For example, when an operator makes an entry through the input section of the central terminal 26A to 26Z, the entered information is sent to the central server 12, which performs processing on the basis of the entered information.

An input section 27 and a display 29 which are communicatively connected to the central server 12 are provided in the central building 18. The input section 27 includes, for example, a keyboard and a mouse to make changes in various settings of the proxy operator selector 22. The display 29 may be, for example, a liquid crystal display (LCD). The display 29 can display a proxy request received from the local server 10 and the results of the proxy query from the proxy operator selector 22.

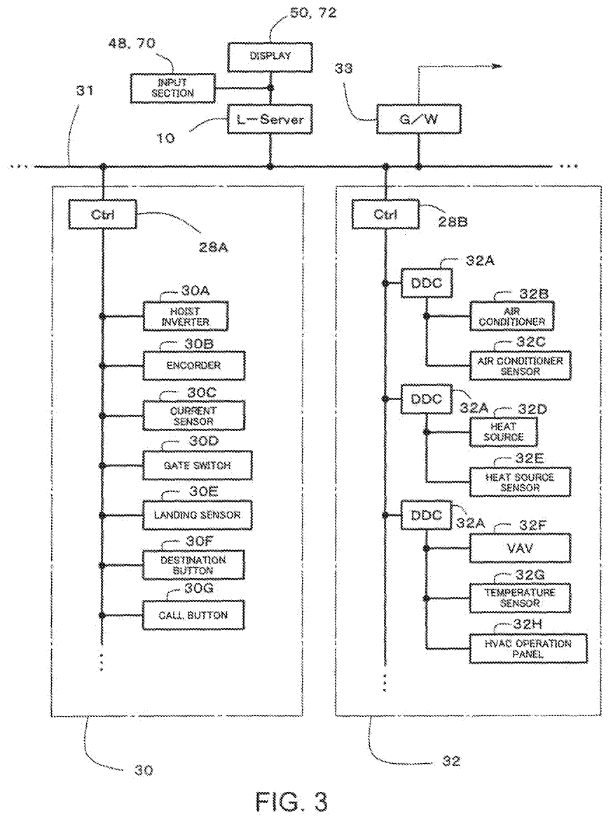

The local server 10 which is installed at a maintained building 14 is a facility management computer (a facility management local server) that is communicatively connected to various devices installed at the maintained building 14. Specifically, at the maintained building 14, a building and energy management system (BEMS) which manages various devices of the facilities in the building is established. FIG. 3 exemplary shows a system configuration diagram in a single maintained building 14. This system includes the local server 10 which is an upper level controller (BACnet operator workstation, B-OWS).

In the building and energy management system, the devices are divided into groups based on the types of the facilities (such as an HVAC, an elevator, and a security system). Each facility group acts as a subordinate of (in other words, is controlled by) a single lower level controller. This lower level controller is also called a “BACnet building controller (B-BC)”. FIG. 3 shows that a control panel 28A is provided as a lower controller of an elevator facility 30, and a controller panel 28B is provided as a lower controller of an HVAC facility 32.

In the elevator facility 30, devices of this facility which act as subordinates of the control panel 28A (a lower level controller) are exemplarily listed as a hoist inverter 30A, an encoder 30B, a current sensor 30C, a gate switch 30D, a landing sensor 30E, destination buttons 30F, and call buttons 30G. In addition to these devices, other elevator-related devices may be connected to the control panel 28A.

In the HVAC facility 32, devices of this facility which act as subordinates of the controller panel 28B (another lower level controller) are first connected to direct digital controllers (DDC) 32A. Various devices are connected to the controller panel 28B via the direct digital controllers 32A. The devices which are connected to the direct digital controllers 32A include, for example, an air conditioner 32B, an air conditioner sensor 32C, a heat source 32D, a heat source sensor 32E, a variable air volume (VAV) unit 32F, a temperature sensor 32G, and an HVAC operation panel 32H.

As described above, in the building energy management system, controlling means have a hierarchical structure, including the local server 10 (B-OWS) which is an upper level controller, the controller panels 28A, 28B (B-BC) which are lower level controllers, and direct digital controllers 32A (DDC) which are controllers at a level lower than the lower level controllers. Respective controlling means have different functions.

For example, the local server 10 which is the upper level controller (B-OWS) may display screens and enable settings using displays 50, 72 and input sections 48, 70 (refer to FIG. 1), which are communicatively connected to the local server 10. For example, management information of the entire system may be centrally managed by browser software or the like of the local server 10. As described below, in cooperation with the central server 12, the local server 10 enables proxy maintenance operations to be performed by maintenance operators 24A to 24Z at the central building 18.

The controller panels 28A, 28B which are the lower level controller (B-BC) mainly perform controlling functions, and manage point data at measurement points of various types, schedule controls, and others, in cooperation with the direct digital controllers 32A (DDC). The controller panels 28A, 28B also function as a gateway for a communication protocol (for example, LonWorks) with the subordinate devices and a communication protocol (BACnet) with the local server 10.

The direct digital controllers 32A control start and stop of the devices in accordance with a schedule control. In response to a stop command from the controller panel 28B, the direct digital controllers 32A stop (such as by cutting power supply and completely closing valves) the devices under control. The direct digital controllers 32A also send values sensed by respective sensors to the controller panel 28B.

The controller panels 28A, 28B which are lower level controllers (B-BC) and the local server 10 which is the upper level controller (B-OWS) communicate with each other through a network 31 (BACnet network) compliant with building automation and control networking (BACnet) protocol. Detail description of the BACnet protocol is omitted below as required because the BACnet protocol is defined in standard 135-2012 of The American Society of Heating, Refrigerating and Air-Conditioning Engineers (ASHRAE) and the corresponding ISO standard ISO16484-5.

The controller panels 28A, 28B that are lower level controllers and their subordinate devices (various devices such as the direct digital controllers 32A and the hoist inverter 30A) can communicate with each other through a network such as a local operating network for works (LonWorks) or a vendor-specific network of the facility.

The local server 10 which is the upper level controller and the controller panels 28A, 28B which are lower level controllers communicate with each other through the network 31 compliant with the BACnet protocol. The local server 10 is further communicatively connected to the central server 12 via the network line 16 (refer to FIG. 1) such as the Internet via a gateway 33 or other devices.

In the BACnet protocol, various devices of the facilities of the maintained building 14 are modeled as objects abstracted as an entity, a function, or other elements. The objects are assigned with properties.

For example, Obj_Identifier which is a property to identify the object includes a device name (for example, “landing sensor”) and an instance which is an identification number (for example, a landing sensor 1, a landing sensor 2, etc.) which identifies each device of the same type. As such, in the BACnet protocol, identification information of a specific device can be obtained.

Multiple objects related to operation statuses such as a start/stop object, an alarm signal object, an emergency stop object may be set to a single elevator. Further, properties are assigned to the respective objects. In other words, in the BACnet protocol, various operation statuses of a specific device can be obtained.

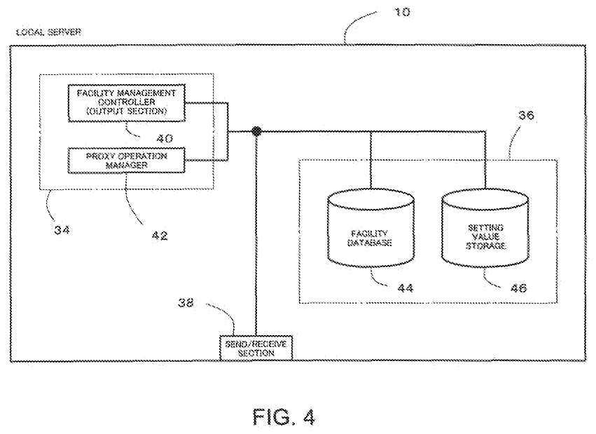

FIG. 4 exemplarily shows details of the local server 10. The local server 10 (facility management local server) includes a CPU 34, a memory 36, and a send/receive section 38 which is an input/output interface.

Similarly, for the central server 12, the memory 36 may be configured with volatile or nonvolatile memories (storage media) including, for example, a memory such as a random access memory (RAM) or a read only memory (ROM), or a storage device including a hard disk.

The memory 36 stores programs that cause the local server 10 to function as the processing portions or the databases that are exemplarily shown in FIG. 4. The processing portions or the databases may be established at the local server 10 by reading the storage media such as a CD-ROM or DVD in which the programs are stored.

The local server 10 functions as a facility management controller 40 and a proxy operation manager 42 using the above programs when the CPU 34 reads and executes these programs.

A facility database 44 and a set value storage 46 are established in the memory 36. The facility database 44 stores information of all subordinate devices of the local server 10. For example, the facility database 44 stores objects and properties in the BGACnet protocol and their corresponding specific device names and operation statuses represented by the objects and properties.

The set value storage 46 stores predetermined set values of the devices of various types. For example, in an elevator facility, the set value storage 46 stores set values such as floors to be skipped and floors on which the elevator is forced to stop.

The facility management controller 40 is a main controller that controls the facility management system of the maintained building 14. The facility management controller 40 controls respective subordinate devices.

The facility management controller 40 receives signals of various types that show operation status of the devices of various types received by the controller panels 28A, 28B via the send/receive section 38. Signals of various types showing operation statuses may be diverse. The facility management controller 40 receives signals indicative of, for example, a current value, an air flow rate, a temperature, a current landing floor, and destination floor buttons and call buttons that are turned ON.

Based on the received various signals showing operation statuses of the devices of various types, the facility management controller 40 issues control signals of the respective devices via the send/receive section 38. For example, as described above, the facility management controller 40 identifies the source device of the signal by checking the received Object_Identifier and the facility database 44. Further, regarding the signals containing the same property and the same instance, the facility management controller 40 obtains the operation status of the device by determining what is indicated by the signal by referring to the facility database 44.

For example, when the source device is a destination button which designates the fifth floor as the destination and the signal indicates ON, the facility management controller 40 determines whether or not the fifth floor is set to be a floor to be skipped by referring to the setting value storage 46. If not, the facility management controller 40 sends a control signal to the control panel 28A to control the hoist inverter 30A to lift the elevator car to the fifth floor.

The facility management controller 40 can also change the various set values stored in the set value storage 46. Set values of various types may be changed, for example, during maintenance of the maintained building 14. For example, when a certain floor of the maintained building 14 is under renovation, this floor can be changed from an accessible floor on which the elevator is allowed to be stopped to a skipped floor, in order to prevent general passengers from entering that floor.

As shown in FIGS. 1 and 3, the input section 48 and the display 50 are communicatively connected to the local server 10. The input section 48 includes, for example, a keyboard and a mouse. The display 50 is, for example, an LCD. The input section 48 and the display 50 may be part of a monitoring computer of the maintained building 14.

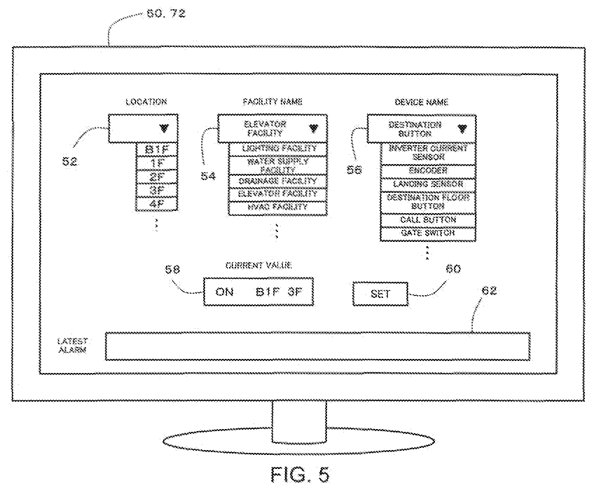

FIG. 5 shows a sample screen of the display 50, displaying set values of various devices stored in the set value storage 46. Device information stored in the facility database 44 is also displayed on the screen.

As shown in FIG. 5, the set value changing screen shows a device location box 52, a facility name box 54, a device name box 56, a current value box 58, a setting change button 60, and a latest alarm message box 62.

In the device location box 52, the installation location (installation floor) of the device whose set values are to be changed is entered. In the facility name box 54, the name of the facility, including the device whose set values are to be changed, is entered. In the device name box 56, the name of the device, which is included in the selected facility, is entered. Any of the boxes 52, 54, 56 may be provided with a drop-down menu to assist the entry.

In the sample screen shown in FIG. 5, the location has not been entered, while “elevator” is entered as the facility and “destination button” is selected as the device name.

The current value box 58 shows a set value for the selected device. To change the set value, the setting change button 60 is pressed (or clicked).

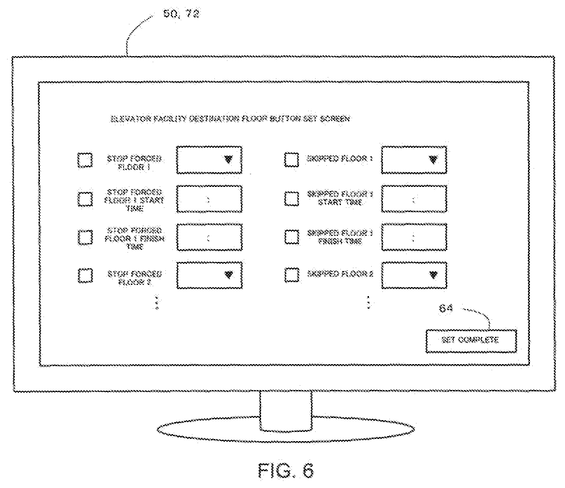

FIG. 6 shows a sample set value changing screen. This sample screen shows a setting screen for the destination button of the elevator designated in FIG. 5. As shown in FIG. 5, entry boxes of enforced-|stop floors|[STB 1] [symbol] and the start time and the finish time of activation of the setting are provided as set values for the destination button. Entry boxes of skipped floors, and the start time and the finish time of activation of the setting, are also provided. Settings of two or more stop-forced floors and skipped floors may be available.

On the screen shown in FIG. 6, settings of the stop-forced floor, the skipped floor, and the start time and the finish time of activation of these settings are changed. Then, the settings are updated to the settings set on the screen when a set complete button 64 is pressed (or clicked).

Although, in the above description, the settings of the devices are changed by the monitoring computer represented by the input section 48 and the display 50 shown in FIG. 1, it should be noted that the present disclosure is not limited to this embodiment. For example, during a maintenance operation (on-site maintenance operation) at the maintained building 14, a maintenance operator 66 (on-site maintenance operator) who performs the on-site maintenance may be around the device whose settings are to be changed, and change the settings while confirming behavior of the device. For such a case, operations similar to those using the input section 48 and the display 50 may also be performed using the input section 70 and the display 72 of a mobile on-site terminal 68 (hereinafter referred to simply as “on-site terminal”) which is carried by the maintenance operator 66.

For example, the on-site terminal 68 may be the above-described thin client terminal including the display 72 which displays the screen outputted from the local server 10. Set values may be changed on the displayed screen via the input section 70 as required.

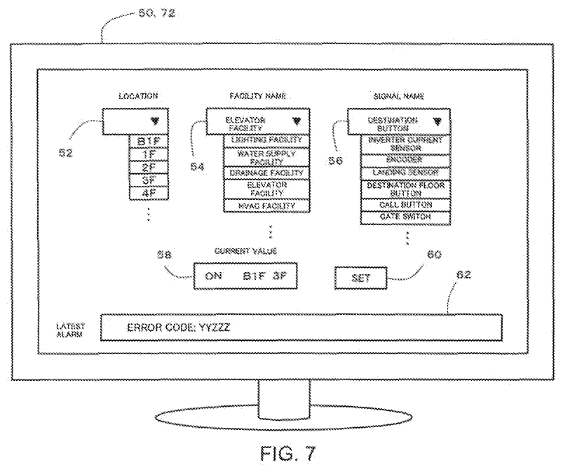

During the on-site maintenance, as a result of a change in the set values stored in the set value storage 46, the device whose settings have been changed may have abnormal behavior. FIG. 7 shows a sample set value changing screen after the set values are changed. The facility management controller 40 (an output section) displays (outputs) an error code in the latest alarm message box 62.

The error code encodes the identification information of the device having the abnormal behavior and the description of the abnormal behavior when abnormal behavior (a performance issue) is detected. In the example shown in FIG. 7, an error code “YYzzz” is displayed on the display 50 (or the display 72).

The error code “YYzzz” includes identification information (device ID: YY) of the device having the abnormal behavior and the code (zzz) that represents description of the abnormal behavior. For example, the device ID (YY) corresponds to the device name and the instance set in the Object_Identifier in the above BACnet protocol, whereas the code (zzz) representing the description of the abnormal behavior corresponds to the current value property (Present_Value) of a binary input (BI) object type.

A case is described below assuming, for example, that the fifth floor is newly set as the floor to be skipped among the destination buttons when changing set values during a maintenance operation. In this case, if the call button on the fifth floor is set to be always ON, these set values conflict with each other. When the elevator facility 30 is switched from an out-of-service state to a maintenance operation state, the control panel 28A receives these conflicting signals (fifth floor skip signal+fifth floor calling always ON signal). As a result, an abnormal signal that indicates an emergency stop of the elevator facility 30 is issued from the control panel 28A. For example, the current value property (Present_Value) of the binary input (BI) object type that indicates an emergency stop is switched from inactive to active.

If the maintenance operator 66 who receives the error code fully understands the error code, the maintenance operator 66 can immediately start a recovery operation from the abnormal status. However, if the maintenance operator 66 has only limited experience, an appropriate recovery operation may be impossible.

In such a case, the proxy operation manager 42 of the local server 10 can request a proxy maintenance operation to the central server 12. As described specifically below, the proxy operation manager 42 enables the proxy maintenance operation through a remote operation from the central terminals 26A to 26Z that are communicatively connected to the central server 12.

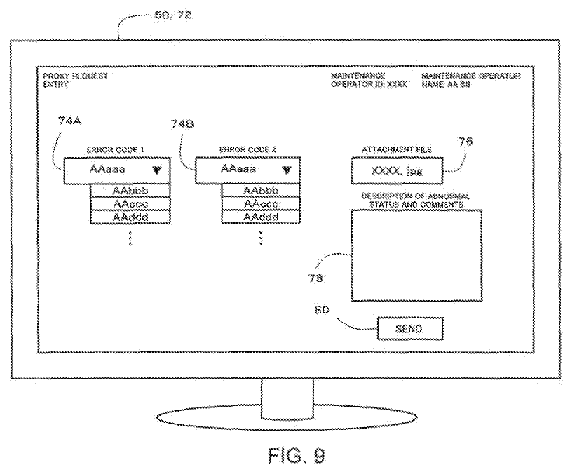

For example, the maintenance operator 66 starts the proxy operation manager 42 by clicking a proxy operation request icon (not shown) with the set value changing screen on the display 50 (or the display 72) being minimized. A proxy operation request screen such as the one shown in FIG. 9 is displayed on the display 50 (or the display 72).

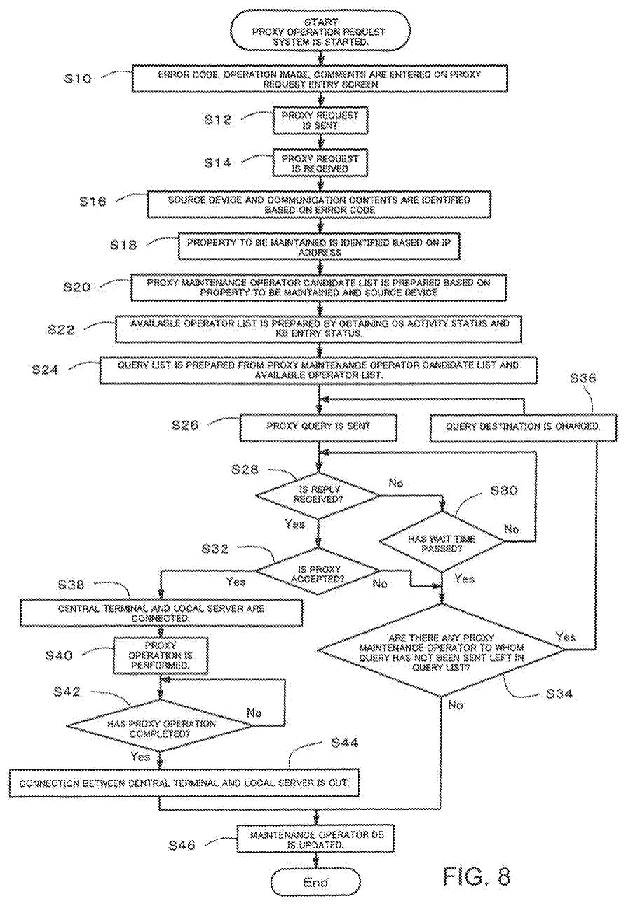

With reference to the flowchart shown in FIG. 8, a proxy operation flow according to an embodiment of the present disclosure is described below. The proxy operation request screen shown in FIG. 9 shows error code entry fields 74A, 74B, an attachment file box 76, a comment entry field 78, and a send button 80. In addition, the ID and the name of the on-site maintenance operator 66 may be displayed.

In the error code entry fields 74A, 74B, the error code displayed in the latest alarm message box 62 in FIG. 7 is entered. To assist the entry, a drop-down menu may be provided. Although, in the embodiment shown in FIG. 9, two error code entry fields are provided, a single, or three or more, error code entry fields may be provided.

Instead of entering the error code in the error code entry fields 74A, 74B, an image data file may be designated in the attachment file box 76. For example, by copying the set value changing screen shown in FIG. 7 using a screen shot function of the input section 48 (or the input section 70), the image data file can be designated in the attachment file box 76.

In the comment entry field 78, description of the on-site maintenance operation that is performed at the time of output of the error code is entered. As described above, an error code may be issued when a set value is changed during an on-site maintenance operation. If the output of the error code can be assumed as a result, the change in the set value may be assumed as the cause. By requesting a proxy operation together with the result and the cause of the error, the analysis of the required operation to recover from the error can be made easier for the request receiving end.

In the above example, the skipped floor setting of the fifth floor destination button in the elevator car is switched from OFF to ON. The on-site maintenance operator 66 enters the description of the on-site maintenance operation in the comment entry field 78 using the input section 48 or the input section 70 (S10 in FIG. 8).

The entries are sent from the proxy operation manager 42 of the local server 10 when the send button 80 shown in FIG. 9 is pressed (clicked) after entering the error code and the description of the on-site maintenance operation being performed at the time of output of the error code (S12). When the entries are sent, the identification information set in the local server 10 is also sent in addition to the error code and the description of the on-site maintenance operation being performed at the time of output of the error code. The identification information may be, for example, an IP address of the local server 10.

The proxy operator selector 22 (FIG. 2) of the central server receives the error code, the description of the on-site maintenance operation being performed at the time of output of the error code, and the identification information of the local server 10, all of which are sent from the proxy operation manager 42 (S14). The error code analyzer 22B of the proxy operator selector 22 identifies the source device of the error code and the contents of the communication (abnormal status description) based on the received error code and the signal description database 22H (S16).

The signal description database 22H stores BACnet objects for all the subordinate devices of the local server 10 at the maintained building 14. Specifically, the signal description database 22H stores a pair of an encoded error code and associated description of the error code, and a pair of encoded device name and an associated device name.

The error code analyzer 22B splits the received error code, for example, into the device portion (YY) and the error description portion (zzz). Then, the error code analyzer 22B extracts device identification information (the device code or the device name) corresponding to the signal YY by matching the device portion (YY) and device codes stored in the signal description database 22H. The device code is, for example, a model number of the device, enabling immediate identification of the device.

The error code analyzer 22B also extracts the description of the abnormal behavior (emergency stop) corresponding to the signal zzz by matching the error description portion signal zzz and an abnormal behavior code stored in the signal description database 22H. The extracted device code (device name) and the abnormal behavior description are sent to the proxy maintenance operator candidate extractor 22C.

Then, the maintenance property identifier 22A of the proxy operator selector 22 identifies the maintained building 14 based on the received identification information (IP address) of the local server 10 and the maintenance property database 22I (S18).

The maintenance property database 22I stores, for each maintained building, information such as identification information of the maintained building (property ID), the address and the name of the maintained building, the IP address of the local server 10, the maintained device, maintenance operation records, and a terminal at the maintained property. The maintenance property identifier 22A calls the maintained building information that has the IP address matching the received identification information (IP address) of the local server 10, and extracts the property ID, the name, and other information of the maintained building. The property ID and the name that have been extracted are sent to the proxy maintenance operator candidate extractor 22C.

The proxy maintenance operator candidate extractor 22C extracts candidates to perform the on-site proxy maintenance operation to make a list of the candidates based on the identification information and the name of the maintained building received from the maintenance property identifier 22A, the device name and the abnormal behavior description received from the error code analyzer 22B, and the maintenance operator database 22J (S20).

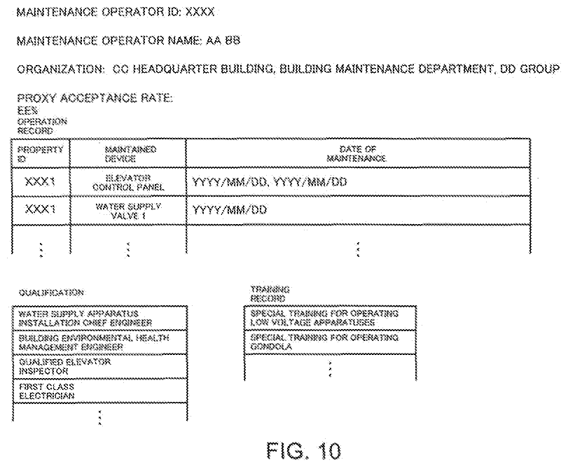

The maintenance operator database 22J stores information on each of the maintenance operators 24A to 24Z who work at the central building 18 (refer to FIG. 1). Specifically, as shown in FIG. 10, the maintenance operator database 22J stores information, such as the identification information (ID), the maintenance operator name, the organization that the maintenance operator belongs to, the proxy acceptance rate, the operation record, the qualifications, and the training record of each of the maintenance operators 24A to 24Z.

Of the above recorded information, the proxy acceptance rate indicates the rate at which the operator has accepted proxy operation requests in the past, indicating “the number of acceptances/the number of requests”. A higher proxy acceptance rate indicates a higher probability that the operator will accept the proxy maintenance operation request.

Based on the property ID received from the maintenance property identifier 22A and the device name received from the error code analyzer 22B, the proxy maintenance operator candidate extractor 22C extracts maintenance operators whose operation record includes the property ID and the device. In other words, the maintenance operators who have maintenance experience at the maintained building identified by the maintenance property identifier 22A and of the device causing the error code are extracted.

The data of the extracted maintenance operators in a form of a proxy maintenance operator candidate list is sent to the request order setter 22D and the terminal activity status obtainer 22E. This candidate list includes, for example, maintenance operator IDs, the maintenance operator names, and proxy acceptance rates.

Among the central terminals 26A to 26Z that are located at the central building 18 and communicatively connected to the central server 12, the terminal activity status obtainer 22E checks operating status of the central terminals 26 that belong to (are assigned to) the maintenance operators listed in the proxy maintenance operator candidate list (S22).

Specifically, the terminal activity status obtainer 22E obtains information as to whether or not the operating systems (OS) of the central terminals 26 have been started, and entry records of the central terminals 26.

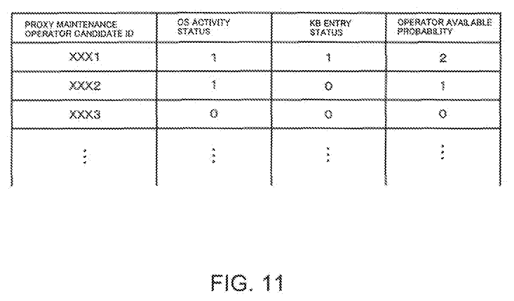

The terminal activity status obtainer 22E further prepares an available operator list shown in FIG. 11. The leftmost column in the available operator list lists maintenance operators 24 (proxy maintenance operator candidates) listed in the proxy maintenance operator candidate list. The terminal activity status obtainer 22E checks whether or not the operating system has been started for each of the central terminals 26 of the maintenance operators 24 listed in the available operator list. When the operating system has been started, “1” is set in the OS activation status of the available operator list. When the operating system is paused, “0” is set in the OS activation status of the available operator list.

The terminal activity status obtainer 22E also checks whether or not any entry is made through the input section of the central terminal 26 (KB entry status) for each of the central terminals 26 of the maintenance operators listed in the available operator list. For example, whether any operation is made through the input section of the central terminal 26 during a latest check period (for example, for last five minutes) is checked. When any operations through a keyboard or a mouse are detected during the check period, for example, the last five minutes, “1” is set in the KB entry status of the available operator list. When no operation through the keyboard or the mouse is detected during the check period, “0” is set in the KB entry status in the available operator list.

Then, the terminal activity status obtainer 22E calculates the sum of the values in the OS activation status and the KB entry status to obtain the operator available probability for each of the proxy maintenance operator candidates. For example, when the OS activation status and the KB entry status are both set to “1”, the obtained operator available probability is “2”. This indicates a high probability that the corresponding maintenance operator 24 is currently available (at the time of issuance of the proxy request) at the desk with the central terminal 26. The prepared available operator list is sent to the request order setter 22D.

The request order setter 22D prepares a query order list (S24) which defines an order to request the proxy operation based on the proxy maintenance operator candidate list received from the proxy maintenance operator candidate extractor 22C and the available operator list received from the terminal activity status obtainer 22E (S24).

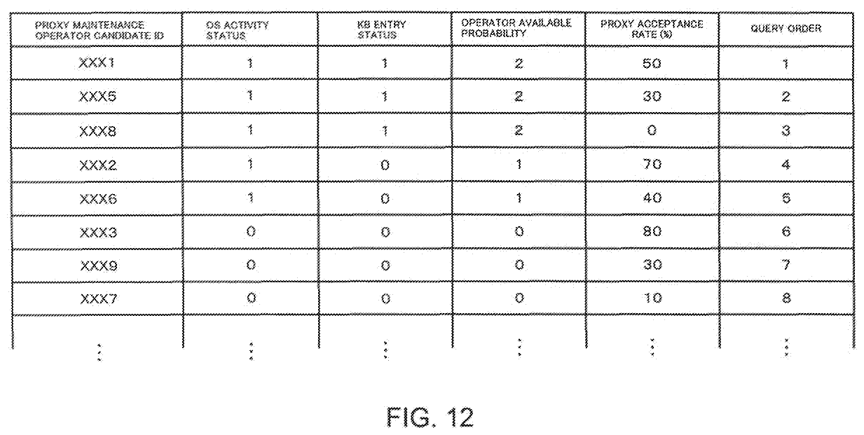

First, the request order setter 22D arranges (sorts) the proxy maintenance operator candidates in a descending order from the highest operator available probability. For example, as is apparent from the comparison between the proxy maintenance operator candidates of IDs XXX8 and XXX2 shown in FIG. 12, even when the proxy acceptance rate is relatively lower, the proxy maintenance operator candidate whose operating system has been started and who made some entries through the input section during the check period is listed before the proxy maintenance operator candidate whose operating system has been started but for which no entries through the input section are detected during the check period.

In this embodiment, the operator available probability has a higher priority as a criteria to order the proxy maintenance operator candidates than the proxy acceptance rate that indicates a probability of acceptance. When the proxy maintenance operator candidate is available at the desk with the central terminal 26, the operator can promptly reply (accept or reject) when receiving the proxy request. In this way, in the present embodiment, replies can be efficiently collected in a short period of time.

When two or more proxy maintenance operator candidates have the same operator available probability, these candidates are arranged in a descending order from the highest proxy acceptance rate. In this way, the query order can be set in the order from the highest acceptance rate with the highest likelihood of prompt reply. The prepared query list is sent to the proxy availability query section 22F.

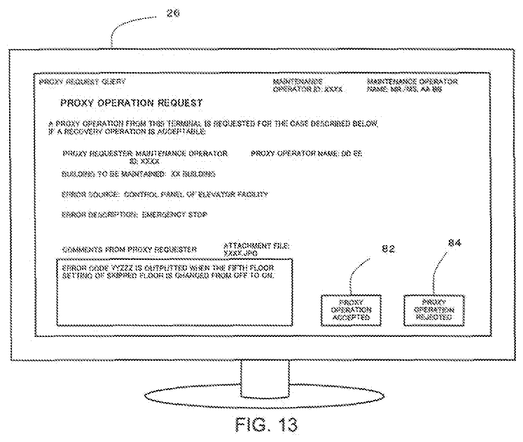

The proxy availability query section 22F makes queries of the proxy operation request in the order (descending order) in the query list (S26). For example, a query screen in FIG. 13 is shown on the display of the central terminal 26 at the query destination.

The query screen describes the proxy operation, showing the maintenance operator ID of the query destination, the name of the maintenance operator, the proxy requester, the name of the property to be maintained, the error sender device, the error description, comments from the proxy requester (the on-site maintenance operator 66) and an attached file (the image at the time of occurrence of the error code, attached on the screen shown in FIG. 9), a proxy operation accept button 82, and a proxy operation reject button 84.

As shown above, the destination of the proxy operation request shown in FIG. 13 is limited to the operators who have maintenance experience of the error sender device, in other words, the maintenance operators 24 who are experts of the error sender device. Further, by informing the maintenance operator 24 the description of the error and the on-site maintenance operations being performed at the time of occurrence of the error, the maintenance operator 24 can grasp the outline of the recovery operations to be required.

When the maintenance operator 24 determines to accept the proxy operation by referring to the screen shown in FIG. 13, the maintenance operator 24 presses (clicks) the proxy operation accept button 82. When the maintenance operators 24 determines that the proxy operation is difficult or impossible, the maintenance operator 24 presses the proxy operation reject button 84.

After sending the query screen, the proxy availability query section 22F determines whether or not a reply (either being accepted or rejected) has been received (S28). When no reply is received, the proxy availability query section 22F determines whether or not a predetermined time period (for example, five minutes) has been passed after sending the query (S30). When the time period has not been passed, the proxy availability query section 22F returns to step S28.

When the wait time period has been passed after the issuance of the query, the proxy availability query section 22F changes the destination of the query. The proxy availability query section 22F determines whether there are any proxy maintenance operation candidates left in the query list to whom the query has not been sent (S34). When a proxy maintenance operation candidate to whom no query has been sent is found, the proxy availability query section 22F changes the destination of the proxy operation request (S36). For example, the proxy maintenance operation candidate immediately below the current query destination is selected as the query destination.

The proxy availability query section 22F returns to step S28. When receiving a reply, the proxy availability query section 22F determines whether the reply indicates acceptance or rejection (S32). When rejected, the proxy availability query section 22F proceeds to step S34.

When the proxy availability query section 22F receives a reply indicating that the proxy operation is accepted, the proxy availability query section 22F sends, to the connection establisher 22G, the identification information (IP address) of the central terminal 26 from which the accepting reply has been sent, and the identification information and the name of the maintenance operator 24 who is the operator of the center terminal 26. The proxy availability query section 22F also sends, to the connection establisher 22G, the identification information (IP address) of the local server 10 at the maintained building 14 from which the proxy operation request has been sent.

The connection establisher 22G communicatively connects the central terminal 26 and the local server 10 based on the received identification information of the central terminals 26 and the local server 10 (S38) such that the facility management system (refer to FIG. 5) of the local server 10 can be operated from the central terminal 26 (S40).

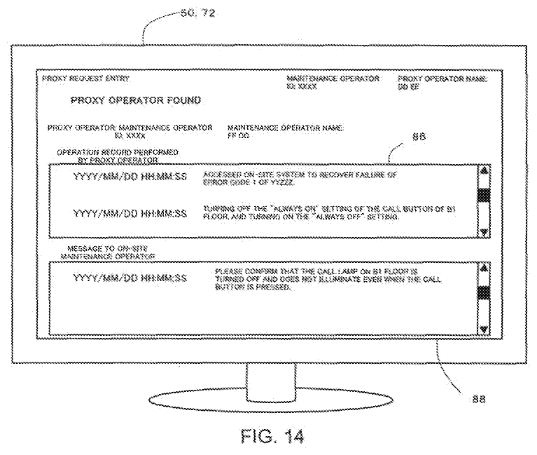

On this occasion, a proxy accepted screen such as the one shown in FIG. 14 generated by the proxy operation manager 42 is displayed on the display 50 or the display 72 of the on-site terminal 68 (refer to FIG. 1) at the maintained building 14. The proxy accepted screen displays the identification information (ID) and the name of the proxy operator. The proxy accepted screen displays a proxy operation record comment box 86 that shows the description of the remote operation (proxy operation) performed from the central terminal 26 by the proxy operator. From the proxy operation record comment box 86, the on-site maintenance operator 66 can learn the recovery operation.

The proxy accepted screen also displays an on-site operation comment box 88 which shows instructions from the proxy maintenance operator to the on-site maintenance operator 66 regarding the on-site checking operations. The on-site maintenance operator 66 performs the checking operations at the maintained building 14 in accordance with the instructions in the comment box 88.

After the proxy operation by the proxy maintenance operator and the checking operation by the on-site maintenance operator 66 are completed, the proxy operation is finished if no error code is issued (S42). The proxy maintenance operator sends a connection cut command from the central terminal 26 to the connection establisher 22G. In response, the connection establisher 22G cuts the communication between the central terminals 26 and the local server 10 (S44).

When the communication is cut, a command indicating the completion (success) of the proxy operation is sent to the proxy operator selector 22 from the central terminal 26. The proxy operator selector 22 updates the maintenance operator database based on this proxy operation result (S46). For example, the proxy acceptance rate of each proxy maintenance operator candidate is updated.

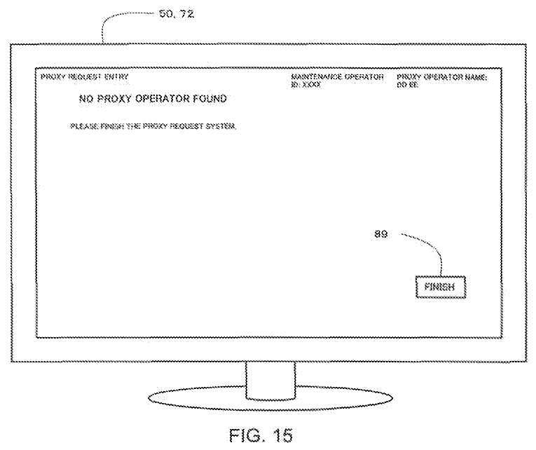

In step S34, when rejection replies are repeated for the proxy operation requests and no proxy candidates who have not received the proxy operation requests are left in the list, a message such as the one shown in FIG. 15 showing that no proxy operators have been found is displayed on the display 72 or the display 50 of the on-site terminal 68. In response to this message, the on-site maintenance operator 66 performs, at the maintained building 14, operations such as a temporary suspension of the use of the facility including the device from which the error code has been issued.

The proxy operation (proxy request operation) finishes when the on-site maintenance operator 66 presses (clicks) a finish button 89 displayed on the display 72 or the display 50 of the on-site terminal 68. When the finish button 89 is pressed, the on-site terminal 68 sends a command to the proxy operator selector 22 informing of finish (failure) of the proxy operation. The proxy operator selector 22 updates the maintenance operator database 22J to reflect the result (accepted/rejected) of the series of proxy requests (S46).

### Another Embodiment of the Present Disclosure

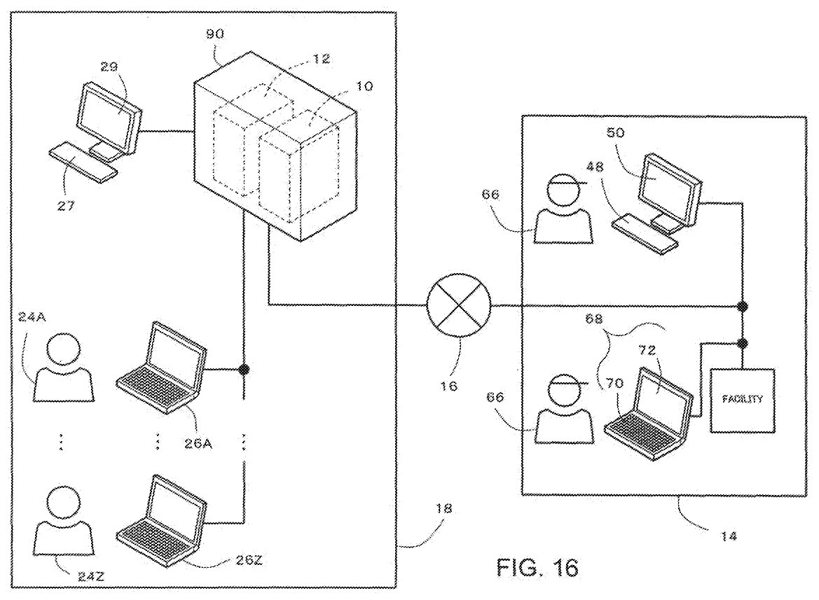

Although, in the embodiment shown in FIG. 1, the local server 10 (facility management local server) is installed at the maintained building 14 while the central server 12 (proxy management server) is installed in the central building 18, the present disclosure is not limited to this embodiment. For example, as exemplarily shown in FIG. 16, a main server 90 which integrates the local server 10 and the central server 12 may be installed as a cloud server in the central building 18. In this case, the local server 10 and the central server 12 are virtually configured in the main server 90 such that resources are allocated as required.

Also in this embodiment, the displays 50, 72 installed at the maintained building 14 may display the screens of the facility management system controlled by the local server 10, as well as the corresponding screens after changes are made, and the proxy operation request screen. Further, data can be input as required to these screens from the input sections 48, 70. The input data is sent to the local server 10 of the main server 90 where the data are processed as required.

Although, in the above embodiments, the order of the proxy maintenance operator candidates is determined based on the available operator list and the proxy acceptance rate, the present disclosure is not limited to these embodiments. For example, after the proxy maintenance operator candidate list is prepared in step S20 in FIG. 8, a candidate may be randomly extracted from the list to request the proxy operation.

### REFERENCE SIGNS LIST

10 local server (facility management local server), 12 central server (proxy management central server), 14 maintained building, 18 central building, 22 proxy operator selector, 22A maintenance property identifier, 22B error code analyzer, 22C proxy maintenance operator candidate extractor, 22D request order setter, 22E terminal activity status obtainer, 22F proxy availability query section, 22G connection establisher, 22H signal description database, 22I maintenance property database, 22J maintenance operator database, 24 central maintenance operator, 26 central terminal, 40 facility management controller, 42 proxy operation manager, 46 set value storage, 48, 70 input section at the maintained building, 50, 72 displays at the maintained building, 52 device location box, 54 facility name box, 56 device name box, 58 current value box, 60 setting change button, 62 latest alarm message box, 64 set complete button, 66 on-site maintenance operator, 68 on-site terminal, 74A, 74B error code entry field, 76 attachment file box, 78 comment entry field, 82 accept button, 84 reject button, 86 proxy operation record comment box, 88 on-site operation comment box, and 90 main server.

1. A facility management local server communicatively connected to a device of a facility of a maintained building, the facility management local server comprising:
a send section configured to send a control signal to the device;
a receive section configured to receive a signal indicative of an operation status of the device;
an output section configured to output an error code that encodes identification information of the device and description of an abnormal status when abnormal behavior of the device is detected;
a set value storage configured to store a set value of the device; and
a proxy operation manager communicatively connected to a proxy management central server, the proxy operation manager configured to enable a proxy maintenance operation through a remote operation from a maintenance operator's terminal communicatively connected to the proxy management central server when the error code is outputted during a maintenance operation at the maintained building to change a set value stored in the set value storage,
wherein the proxy operation manager is configured to display a proxy request screen on a display disposed at the maintained building, and the proxy request screen comprises an entry field for the error code and another entry field for description of the maintenance operation being performed at the maintained building at time of output of the error code.

2. The facility management local server according to claim 1, wherein
the proxy operation manager sends identification information of the facility management local server when sending, to the proxy management central server, the error code and the description of the maintenance operation entered on the proxy request screen.

3. The facility management local server according to claim 1, wherein
the proxy operation manager is configured to display, on the display, description of the remote operation performed through the terminal and description of a checking operation to be performed at the maintained building.

4. A proxy management central server communicatively connected to a facility management local server communicatively connected to a device of a maintained building, the facility management local server configured to send a control signal to the device and receive a signal indicative of an operation status of the device, the proxy management central server comprising:
a proxy operator selector configured to select a maintenance operator who performs a proxy operation from a terminal through a remote operation to the local server when receiving, from the local server, an error code encoding identification information of the device and description of an abnormal status, outputted when abnormal behavior of the device is detected, and proxy request information comprising description of a maintenance operation being performed at the maintained building at a time of output of the error code, the maintenance operator being selected from maintenance operators who operate terminals that are communicatively connected to the proxy management central server.

5. The proxy management central server according to claim 4, wherein
the proxy operator selector comprises:
an error code analyzer configured to analyze the identification information of the device having the abnormal status and the description of the abnormal status using the received error code, and
a property identifier configured to obtain information on the maintained building based on identification information of the local server sent from the local server along with the error code and the description of the maintenance operation, when receiving the proxy request information.

6. The proxy management central server according to claim 5, wherein
the proxy operator selector further comprises:
a candidate extractor configured to extract, from the maintenance operators who operate the terminals, maintenance operators who have maintenance experience for the maintained building identified by the property identifier based on an operation record of the maintenance operators,
a terminal activity status obtainer configured to obtain information as to whether or not an operating system of the terminal has been started, and an entry record to the terminal, and
a request order setter configured to determine an order of the maintenance operators extracted by the candidate extractor to request the proxy operation, based on the information as to whether the operating system has been started and the entry record to the terminal.

7. The proxy management central server according to claim 6, wherein
the request order setter is configured to determine a request order of the maintenance operators, to request a remote operation to the local server, by assigning a higher priority to the maintenance operators
who have been extracted by the candidate extractor,
whose operating system has been started, and
who have performed an entry operation to the terminal during a latest checking period
than to the maintenance operators
who have been extracted by the candidate extractor,
whose operating system has been started, but
who have performed no entry operation to the terminal during the latest checking period.

8. The proxy management central server according to claim 7, wherein
the proxy operator selector comprises a maintenance operator database configured to store, for each of the maintenance operators, a proxy acceptance rate indicative of a rate at which the maintenance operator has accepted proxy operations, and
the request order setter is configured to determine the request order in a descending order from a highest proxy acceptance rate among the maintenance operators
who have been extracted by the candidate extractor,
whose operating system has been started, and
who have performed an entry operation to the terminal during the latest checking period.
